(19) United States
(12) Patent Application Publication
(10) Pub. No.: US 2003/0232629 A1
(43) Pub. Date: Dec. 18, 2003

(54) System and method for providing a voice call waiting during an active data call

(75) Inventors: Ke-Chi Jang, Plano, TX (US); Chung-Chung Wang, Plano, TX (US); Geng Wu, Plano, TX (US)

Correspondence Address: HAYNES AND BOONE, LLP, 901 MAIN STREET, SUITE 3100, DALLAS, TX, 75202, US

(73) Assignee: Nortel Networks Limited, St. Laurent (CA)

(21) Appl. No.: 10/324,273

(22) Filed: Dec. 19, 2002

Related U.S. Application Data
(60) Provisional application No. 60/360,792, filed on Mar. 1, 2002.

(51) Int. Cl. H04Q 7/20

(52) U.S. Cl. 455/552.1

(57) ABSTRACT

A method and system is disclosed for admitting a voice call while a mobile station (MS) is engaging in a data call in a telecommunication network. First, a predetermined message is sent from a base station (BS) to the MS prohibiting the MS from initiating a data call for a predetermined period of time after receiving the predetermined message. The BS then releases a communication channel to be used for the voice call, and initiates the voice call, and the data call is reconnected after either voice call is completed.

### CROSS REFERENCE

This application claims the benefits of U.S. Provisional Application Serial No. 60/360,792, which was filed on Mar. 1, 2002.

### BACKGROUND OF THE INVENTION

The present invention relates generally to telecommunication systems, and more particularly, to a system and method for arranging a voice call waiting during an active data call.

The advancement of telecommunication technologies has brought tremendous feature depth to communication networks. Both voice and data calls can now be carried on the network. These two different types of services are usually carried on sequentially, not simultaneously. It is not unusual that one call may come in when another is going on. In CDMA based networks, no voice calls can be provided when a user is engaging a data call. The network is not able to page the MS used by the user, or provide the user a call waiting indication until the current call is terminated.

What is needed is a method and system for providing a call waiting service to a MS.

### SUMMARY OF THE INVENTION

A method and system is disclosed for admitting a voice call while a mobile station (MS) is engaging in a data call in a telecommunication network. First, a predetermined message is sent from a base station (BS) to the MS prohibiting the MS from initiating a data call for a predetermined period of time after receiving the predetermined message. The BS then releases a communication channel to be used for the voice call, and initiates the voice call, and the data call is reconnected after either voice call is completed.

### BRIEF DESCRIPTION OF THE DRAWINGS

FIG. 1 illustrates a simplified wireless communication system.

FIG. 2 is a flow diagram showing call flows between the BS and the MS in order to carry out a call waiting service.

FIG. 3 is a process flow for starting a voice call between the BS and the MS.

### DESCRIPTION OF THE PREFERRED EMBODIMENT

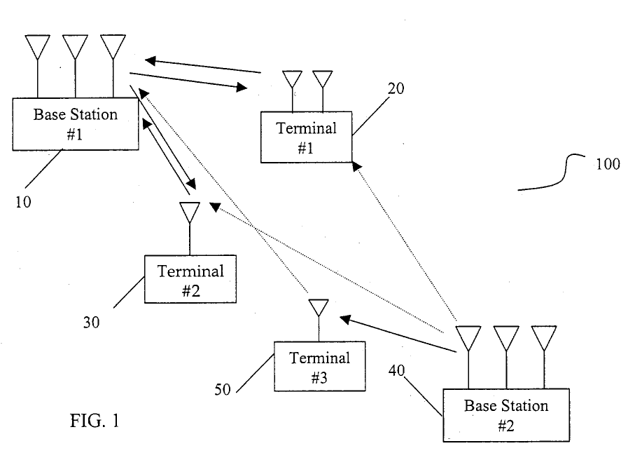

FIG. 1 illustrates a simplified wireless communication system 100 wherein a call control and management device such as a first base station (BS) 10 communicates with its mobile stations (MS) 20 and 30, and a second base station 40 communicates with its own MSs such as MS 50. When the communications are being carried out between the base stations and the MSs, the signals of interest may be largely controlled and directed by the BS. The communication initiated by the MS and destined at the BS is referred to as the uplink communication, while the reverse is referred to as the downlink communication.

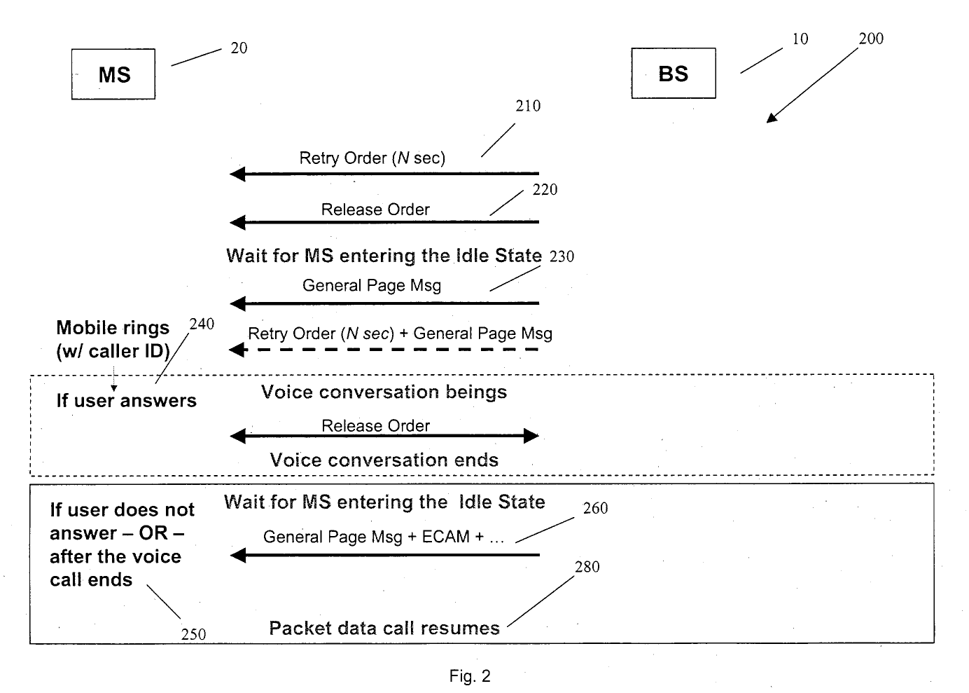

FIG. 2 illustrates a flow diagram 200 showing call flows between the BS 10 and the MS 20 in order to carry out a call waiting service. For illustration purposes, it is assumed that a voice call comes in when an active packet data session or a data call is in progress. Upon receiving the incoming call request, the BS 10 prepares and sends a predetermined message such as a Retry Order message to the MS 20 in step 210. The Retry Order message specifies a time duration from the moment the MS receives this message in which no packet data call may be originated from the MS 20. This time duration may be several seconds in some examples. Then, in step 220, the BS 10 sends instructions to release the traffic channel that is in use for communication with the MS 20. This makes the data call go dormant when the MS enters an Idle State. In step 230, the BS then pages the MS for the voice call using conventional methods indicating to the MS that a voice call is now coming in. Based on the configuration, the MS 10 may ring with or without a caller identifier. If the user answers the voice call (e.g., by sending a page response message) in step 240, the voice call pursues. When the call is completed, the used traffic channel is released. If the user refuses to answer the voice call in step 250, the BS 10 waits for the MS to enter the Idle State, and resumes the dormant data call by sending a general paging message and other related messages (such as a channel assignment message) so that it can be assigned a traffic channel (as it normally would) in step 260. The data call may then resume in step 280. The step 260 can also be performed when the voice call is accepted by the MS 20 and subsequently finished. It is noticed that if there is a request received at the BS from the MS for starting a data call between steps 220 and 240, the BS would send another Retry Order message down to the MS to make sure that the MS is not initiating the data call for a period long enough so that it does not disturb the MS from entering the voice call. This scenario can happen when the prior Retry Order does not set the time long enough to prevent the MS from originating a data call. Therefore, as soon as the traffic channel is released, the MS will try to reconnect the dormant data call or initiate another data call. At this moment, the BS may be just about to send or be sending the first general paging message. Since the MS would not process the general paging message when it is waiting for the BS to respond to its origination message, the BS needs to resend the Retry Order message followed by a new general paging message to start the process again.

It is understood that the Retry Message is used as an example here to illustrate how the BS prohibits the MS from entering into or originating a data call for a period of time. This can be done through other messages that prevent the MS from packet data re-origination. For example, in CDMA based networks, the BS can use a Service Option Control Message (SOCM) to accomplish the same goal as the Retry Order does. Similarly, the general paging message can be the General Page Message, or any other kind such as the Universal Page Message, according to the technology used by the telecommunication network. It is further understood that when the data call is put on hold and the MS is in an Idle State, the PPP session between the BS and the MS is not completely dropped. On the contrary, it remains on the protocol stack on both the MS and its gateway device such as a Packet Data Serving Node (PDSN). As such, it is understood that the dormant state of the data call is not a total disruption.

In another example, the Retry Order message can be replaced by a Flash with Info Message (FWIM) or an Alert with Info Message (AWIM) with the BS knowing that a traffic channel is dedicated to the current data call. In the FWIM or the AWIM message, information such as the caller ID may be attached. The BS may start to measure the time for tearing down the data call after such a message is sent to the MS. Upon receiving the FWIM or AWIM, the MS may ring with a special ring pattern and display the caller ID for the user. If the user accepts the voice call, the MS sends another returning FWIM to the BS. If the user refuses to take the call, the on-going data call is not affected in any way. It can be configured that the BS can repetitively send the FWIM or AWIM message to the MS after a predetermined time period if no response is received from the MS. The BS may also decide to route the incoming voice call to a voice mail system if the user is not picking up the voice call by staying with the data call. It is understood that the BS may also signal the MS for an incoming voice call by sending voice call information to a service node such as an internet call waiting server, which may further send a message to be displayed on a user's computing device such as a laptop. How a user would like to be informed about the incoming voice call can be configured through a user profile database such as the Home Location Register in the telecommunication network or in a mobile station capability information record communicated to the BS through the air.

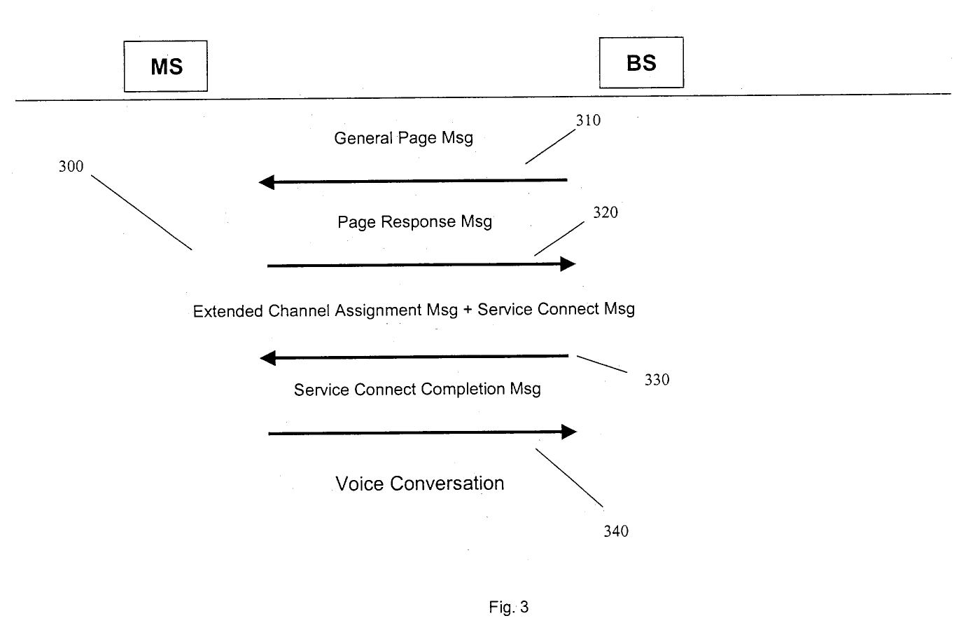

FIG. 3 illustrates a general process 300 for starting a voice call between the BS and the MS. In step 310, the BS sends a general page message to the MS indicating that a voice call is about to be initiated. The MS responds with a page response message back to the BS in step 320 to accept the voice call. The BS then sends a channel assignment message such as the Extended Channel Assignment Message and related messages such as the Service Connect Message (step 330). The MS acknowledges its connection with the BS and sends a confirmative message such as the Service Connect Completion Message back to the BS in step 340, and the BS connects the voice call.

The above disclosure provides many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for admitting a voice call while a mobile station (MS) is engaging in a data call, the method comprising:
sending a first predetermined message from a base station (BS) to the MS prohibiting the MS from initiating a data call for a predetermined period of time after receiving the predetermined message;
releasing by the BS a communication channel for the data call to be used for the voice call, thereby making the data call dormant;
initiating the voice call by the BS; and
reconnecting the data call after the voice call is completed.

2. The method of claim 1 wherein the first predetermined message signals to the MS that the voice call is coming in.

3. The method of claim 1 wherein the first predetermined message provides the MS with a caller ID.

4. The method of claim 1 further comprising waiting the MS to enter an Idle State before initiating the voice call by the BS.

5. The method of claim 1 further comprising sending a second predetermined message further prohibiting the MS from originating a data call when the BS detects that the MS intends to initiate another data call.

6. The method of claim 1 wherein the reconnecting further comprises reconnecting the dormant data call if the user refuses to accept the voice call.

7. The method of claim 1 further comprising moving the voice call to a voice mail system if the MS does not accept the voice call within a predetermined time.

8. A telecommunication system for admitting a voice call while a mobile station (MS) is engaging in a data call, the telecommunication system comprising a base station (BS) for:
sending a first predetermined message to the MS prohibiting the MS from initiating a data call for a predetermined period of time after receiving the predetermined message;
releasing by the BS a communication channel for the data call to be used for the voice call, thereby making the data call dormant;
initiating the voice call by the BS; and
reconnecting the data call after the voice call is completed.

9. The system of claim 8 wherein the first predetermined message signals to the MS that the voice call is coming in.

10. The system of claim 8 wherein the first predetermined message provides the MS with a caller ID.

11. The system of claim 8 further comprising means for waiting the MS to enter an Idle State before initiating the voice call by the BS.

12. The system of claim 8 further comprising means for sending a second predetermined message further prohibiting the MS from originating a data call when the BS detects that the MS intends to initiate another data call.

13. The system of claim 8 wherein the BS further comprises means for reconnecting the dormant data call if the user refuses to accept the voice call.

14. The system of claim 8 wherein the BS further comprises means for moving the voice call to a voice mail system if the MS does not accept the voice call within a predetermined time.

15. A method for admitting a voice call while a mobile station (MS) is engaging in a data call, the method comprising:
receiving a first predetermined message from a base station (BS) at the MS prohibiting the MS from initiating a data call for a predetermined period of time after receiving the predetermined message;
detecting that a communication channel for the data call released to be used for the voice call;
detecting that the voice call is initiated by the BS; and
reconnecting the data call after the voice call is completed.

16. The method of claim 15 wherein the first predetermined message signals to the MS that the voice call is coming in.

17. The method of claim 15 wherein the first predetermined message provides the MS with a caller ID.

18. The method of claim 15 further comprising having the MS enter an Idle State before initiating the voice call by the BS.

19. The method of claim 15 further comprising receiving a second predetermined message by the MS further prohibiting the MS from originating a data call when the BS detects that the MS intends to initiate another data call.

20. The method of claim 15 wherein the reconnecting further comprises reconnecting the data call if the user refuses to accept the voice call.

21. The method of claim 15 further comprising moving the voice call to a voice mail system if the MS does not accept the voice call within a predetermined time.
